(19) United States
(12) Patent Application Publication
(10) Pub. No.: US 2011/0309607 A1
(43) Pub. Date: Dec. 22, 2011

(54) Organizational Notebook System

(76) Inventor: Frances Marie Ramos-Dones, San Juan, PR (US)

(21) Appl. No.: 13/165,843

(22) Filed: Jun. 22, 2011

Related U.S. Application Data
(63) Continuation-in-part of application No. 12/656,243, filed on Jan. 21, 2010.

(51) Int. Cl. B42D 1/00

(52) U.S. Cl. 281/15.1

(57) ABSTRACT

A product and system of notebooks that are color-coded to relate to a particular class or subject. For example, a green notebook could relate to a computer class, a red notebook could relate to compounds' molecular structure, etc. The notebooks are fashioned to employ different calligraphy (first, second, third, quadrille 5 mm, 6 mm, 7 mm and regular lines). As presently contemplated, the notebooks will be available in different, bright colors. By way of illustration and not as a limitation, the constituents may be incorporated into a different color coded product.

### RELATED APPLICATIONS

This application is a continuation in part and claims the benefit of U.S. patent application Ser. No. 12/656,243 filed Jan. 21, 2010.

### BACKGROUND OF THE INVENTION

1. Field of the Invention

The present invention is generally directed to organizational system and kit, and more particularly, to a group of articles linked to an organization central unit for use in educational systems and institutions that enable students to organize and prioritize instructional materials.

2. Discussion of the Background

Some health specialists recommend several organization tools in order to be more successful at work, assist people with brain or memory deficits, maximize academic experience and more. For example, students deserve the best academic experience that will enable them to build a better future. It is crucial to provide students—without distinction of their learning styles—with the tools that will help them maximize their potential.

Acquiring good study habits is essential to academic success. One aspect of acquiring such habits is that of organization. Students at the elementary level and those suffering from different variations of attention deficit disorder (ADD) usually lack organizational skills. This lack of organization translates into disarray in their lockers, desks, notebooks, etc. Often, the student brings the wrong notebook home or to a particular class, further exacerbating the learning process. Most experts agree that organizational skills are learned rather than inherited. It is also agreed that the earlier these skills are learned and developed the better the student's chances for success (not only in an academic environment but also in life).

Psychologists and child/teenager specialists strongly advocate the use of color, as a form of indicia to be used as a medium to raise a child's or teenager's attention level. Heretofore, teachers and parents, especially in the elementary grades, have utilized various methods (stickers, numbers, color markers, etc.) to mark and differentiate notebooks for organizational purposes. Since everyone uses a different method, there was no continuity and the mélange created more confusion for the students. The education sector would certainly welcome a uniform system for identifying notebooks to enhance students' organizational abilities. Thus, student organizational notebook systems solving the aforementioned problems are desired.

### SUMMARY OF THE INVENTION

The present invention is generally related to a organizational system and kit comprising organization central control unit and several articles linked said organization central control unit, wherein said articles comprise notebooks, file folders, envelopes, book labels, index cards, notebook paper, page-marker flags, and binders with indicia, such as color-coded, in order to relate to a particular academic class or subject with said central control unit. For example, a green notebook could relate to a computer class, a light green notebook could relate to a computer laboratory, a yellow notebook could relate to a science class, a red notebook could relate to a compound's molecular structure, etc.

In a first aspect of the present invention, the notebooks for right handed or left handed are fashioned to employ different calligraphy such as first, second, third, quadrille, 5 mm, 6 mm, 7 mm and regular lines, among others.

Another aspect of the present invention is that, as presently contemplated, each notebook will be available in different distinctive indicia, such as bright colors, with matching double-pocket folders for homework, an agenda and the like. Accordingly, the invention provides a system for assisting students to organize and thereby creating a better atmosphere for learning.

Another aspect of the present invention is that said invention provides for improved elements such as binders, folders, envelopes, book labels, index cards, page-marker flags, notebook paper and an agenda, thereof in an arrangement for the purposes described that are inexpensive, dependable and fully effective in accomplishing their intended purposes.

Another aspect of the present invention is to provide a control central unit, wherein said control central unit comprises means to identify indicia with a particular subject matter, means to summarize and show long term tasks, means to prioritize tasks, means to track conduct behaviors, means to track time to performed a task and/or homework and means to illustrate a completed the task.

A further understanding of the nature and advantages of the present invention will become apparent by reference to the examples provided.

### BRIEF DESCRIPTION OF THE DRAWINGS

FIG. 1 shows the organizational system and kit comprising organization central control unit and several articles.

FIG. 2 is an environmental, perspective view of student's using the organizational system and kit according to the present invention.

FIG. 3 is a perspective view of notebooks according to the present invention. Similar reference characters denote corresponding features consistently throughout the attached drawings.

FIG. 4 represents the backpack filled with the articles of the organizational system and kit.

FIGS. 5A and 5B are perspective view of student's organizational notebook system's matching file folders, wherein said folders can be grouped by a binder ring.

FIG. 6 is a perspective view of the organization central control unit wherein said central control unit is organized to present each particular indicia, such as color codes, matching to the corresponding articles.

FIG. 7 is a perspective view of the organization central control unit left page wherein said central control unit is organized into color codes, matching to the corresponding articles.

FIG. 8 is a perspective view of the organization central control unit right page wherein said central control unit is organized into color codes, matching to the corresponding academic articles.

FIG. 9 is a demonstration of some of the organizational system and kit constituents grouped together by matching colors.

FIG. 10 is a perspective of the organizational system and kit color coded index cards.

FIG. 11 is a perspective of the organizational system and kit color coded notebook papers.

FIG. 12 is a perspective of the organizational system and kit color coded plastic envelopes.

FIG. 13 is a perspective of the organizational system and kit coded book labels.

FIG. 14 is a perspective of the organizational system and kit color coded page-marker flags.

FIG. 15 is a perspective of the organizational system and kit color coded ring binder.

### DETAILED DESCRIPTION OF THE DRAWINGS

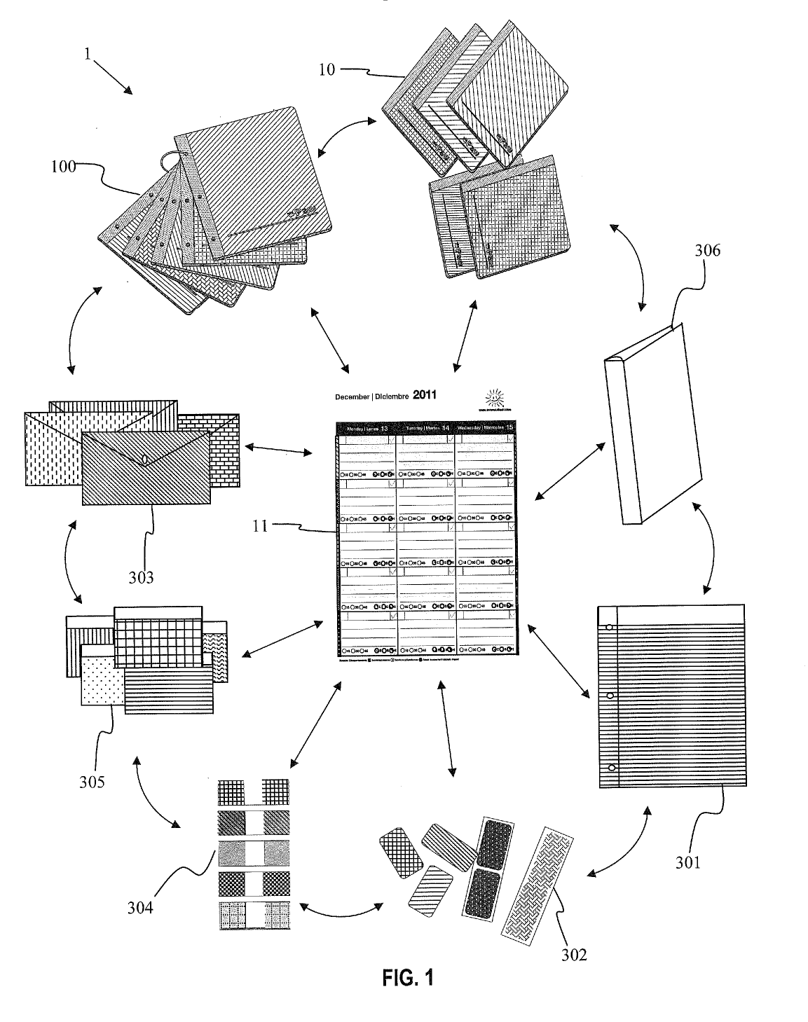

FIG. 1 discloses an organizational system and kit comprising an organization central control unit 11 and several school articles 10, 100, 301, 302, 303, 304, 305, 306, linked to said organization central control unit 11 by means of indicia. The articles comprise notebooks 10, file folders 100, envelopes 303, book labels 302, index cards 305, notebook paper 301, page-marker flags 304 and binders 306 with indicia. The indicia assist with the identification of articles by distinguishing the same type of article from each other. For example, a first notebook and second notebook having structure similarities are distinguish from each other by comprising a first indicia and a second indicia respectively, wherein first indicia is different from the second indicia.

Further the indicia of an article can be related to a different article having a different structure but the same indicia. Having different articles with the same indicia assists the creation of groups under particular indicia. Each particular indicia could represent a particular subject matter, academic class, a case, etc. The articles 10, 100, 301, 302, 303, 304, 305, 306 having the same indicia are further related to the organization central control unit 11. Each article is describe in more details below.

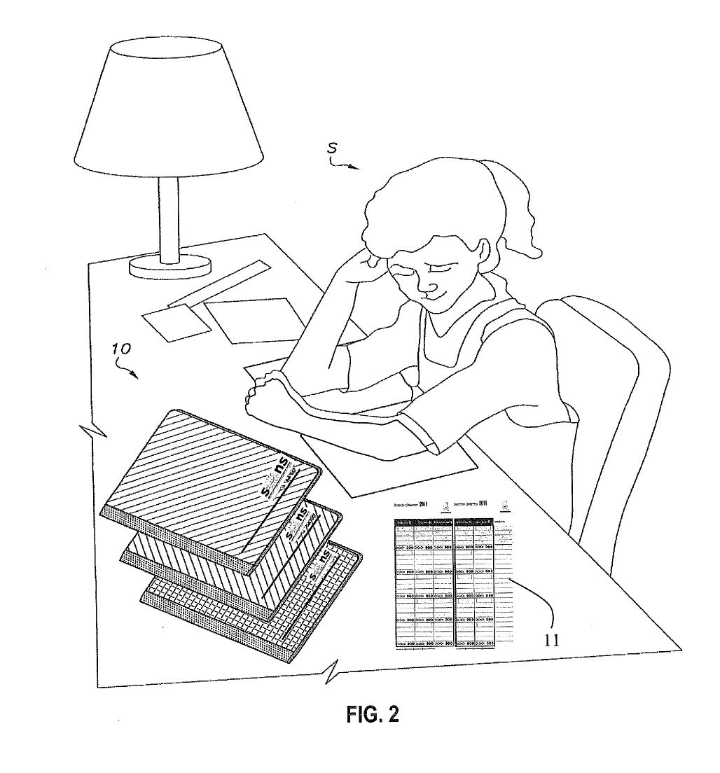

FIG. 2 is directed to a person, such as a student, using the organizational kit 1, including notebooks 10 and control central unit 11.

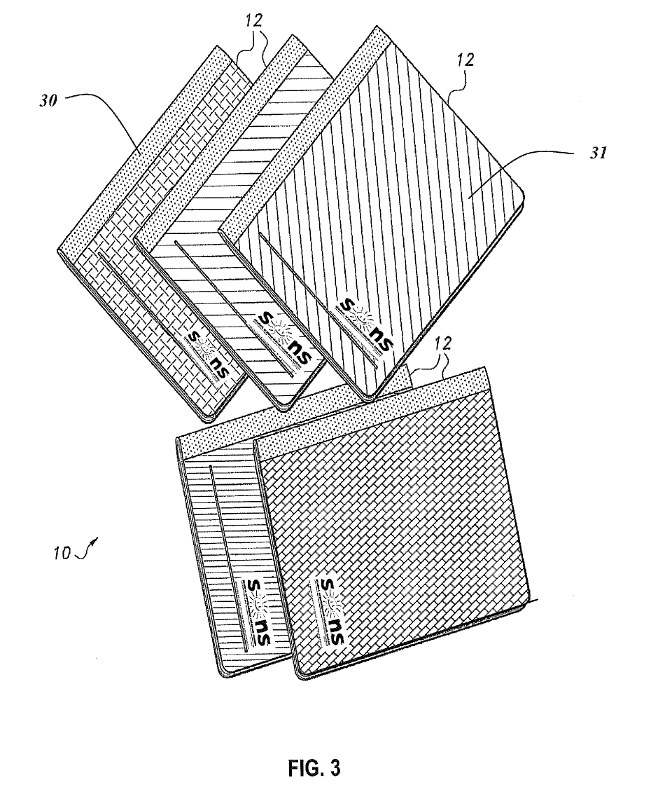

Particularly, FIG. 3 is a perspective view of student's organizational notebooks 10 according to the present invention. Each notebook 12 forms a system comprising multiple notebooks 10. Each notebook 12 comprises a distinctive indicia, such as different color or texture, and each color represents a particular subject, as indicated above. Each notebook spine 30 could have the same indicia for all the notebooks or it could have uniform indicia, such as the same color as the notebook's cover 31 to provide easy identification of academic class or subject when it is placed inside a container T. This arrangement creates less confusion for the student. The student is more likely to associate a color with a particular class, thereby organizing school work by subject matter. Although five notebooks are shown, it should be recognized that the number of notebooks utilized would correspond to the number of classes taken by the student.

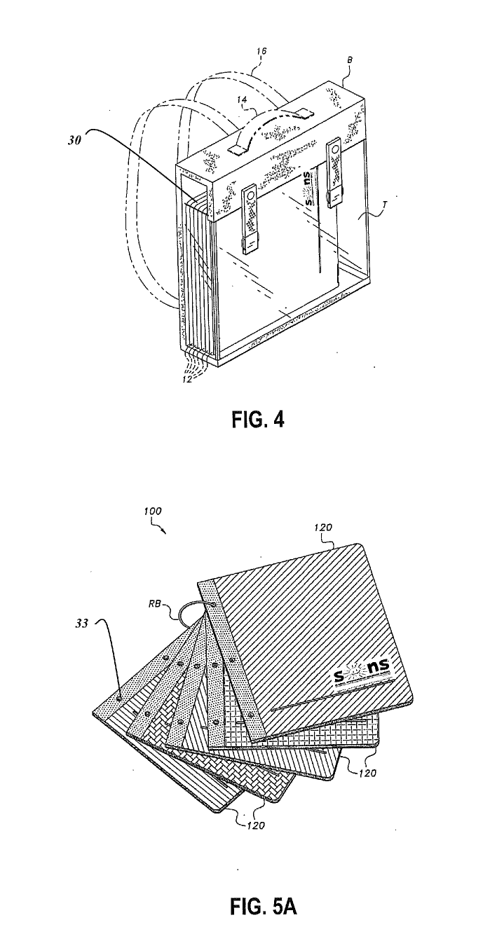

FIG. 4 represents a backpack or container T filled with the student's organizational notebooks 10. The notebooks 10 are placed with their spine 30 up to provide easy identification of academic class or subject. This allows the student to save time searching for the right notebook, thus improving his or her performance.

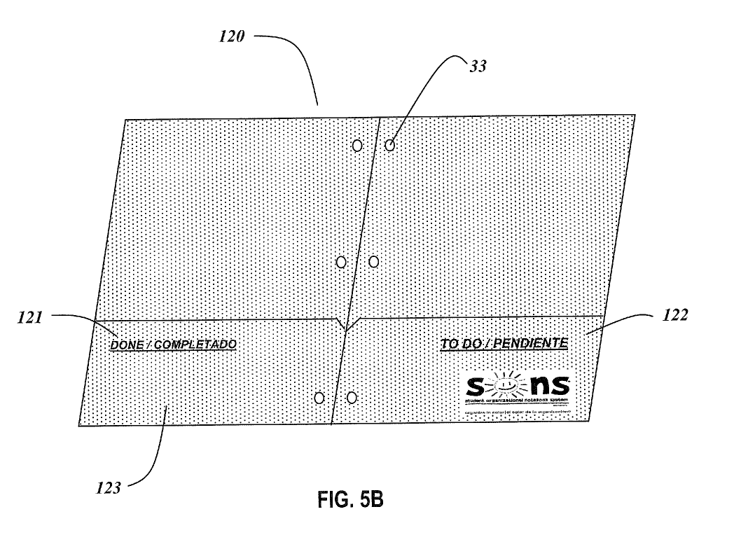

FIG. 5A is a perspective view of the organizational system and kit matching file folders 100, wherein said folders 100 can be grouped by a binder ring RB. Each folder 120 is marked or comprises indicia, such as color coded with all the constituents of the present invention. The folders 100 can be easily ungrouped if a professor needs to keep it to grade school work.

FIG. 5B is a perspective view of a the organizational system and kit matching file folder 120. Said folder 120 has interior pockets 123, wherein the right pocked is labeled “To Do” 122 and the left pocked is labeled “Done” 121. The structure of the folder 120 allows the student to easily structure and organize his tasks.

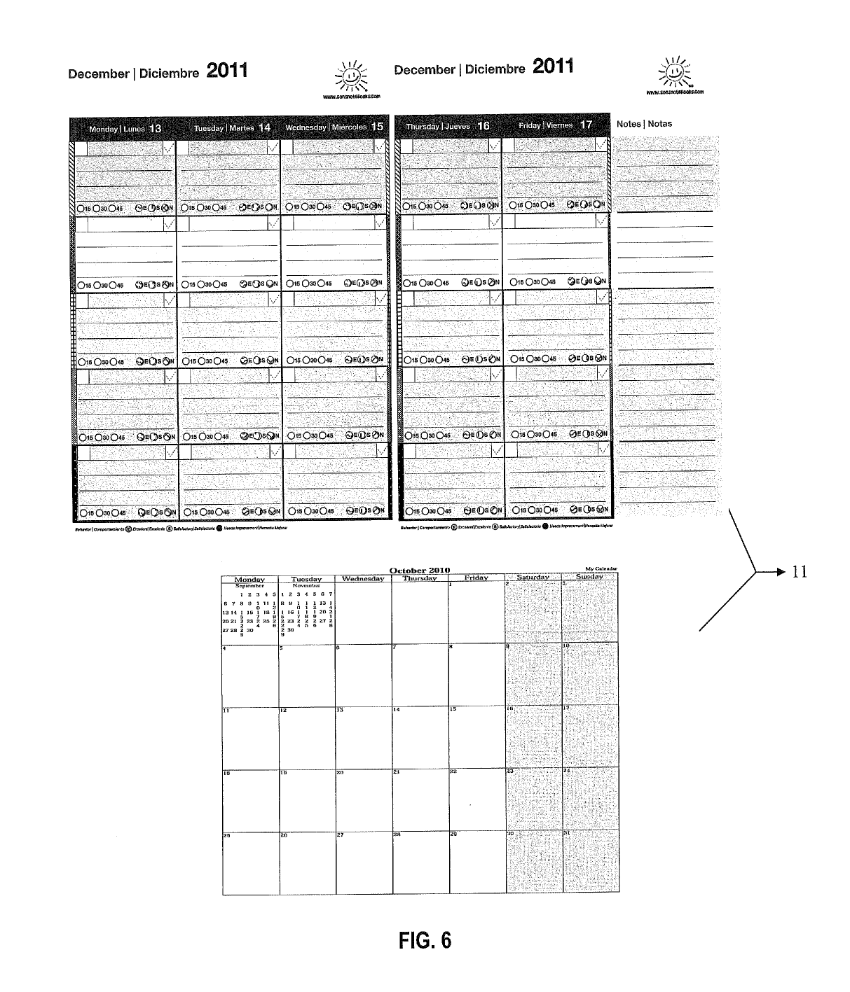

FIG. 6 is a perspective view of the organization central control unit, for example a student organizational notebook system's agenda 11 wherein such agenda is arranged into grouped printing material, such as paper, organized into color codes, matching to the corresponding academic class or subject.

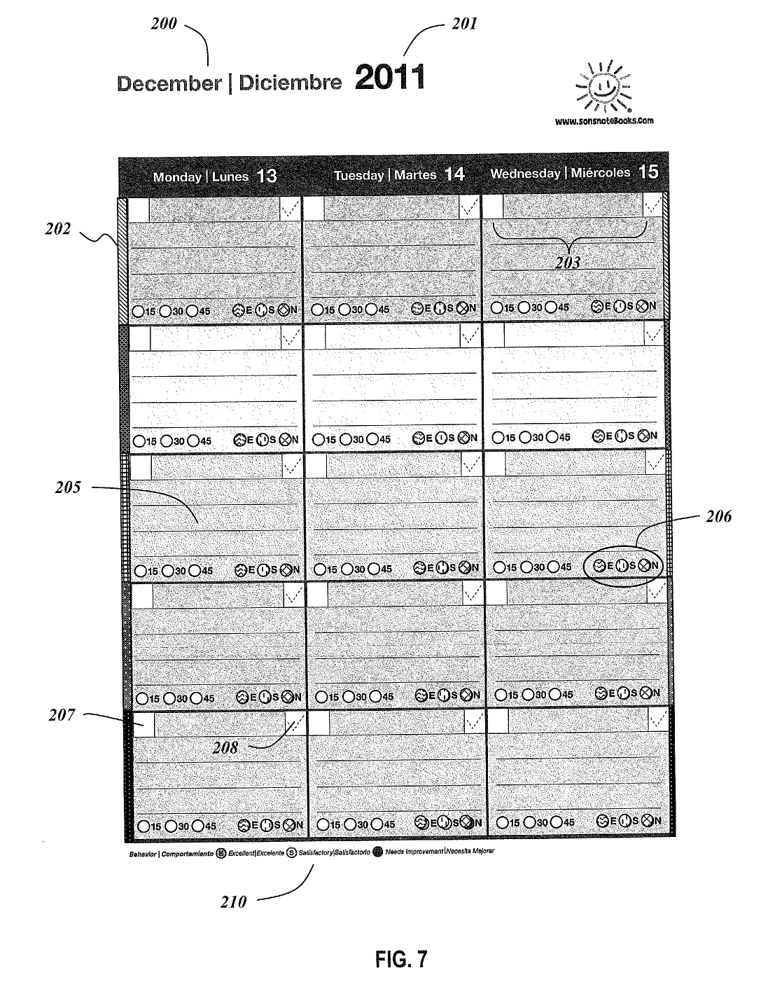

FIG. 7 is a perspective view of left page of the student organizational notebook system's agenda 11 dated within the current academic year 200, 201, wherein said page is organized into color codes 202, matching to the corresponding academic class or subject. The agenda 11 may or may not have printed classes or subjects. Preferably the only academic class or subject identification method is by colors, which promotes the student to develop and improve memorization skills. One of the constituents of the agenda 11 are two small boxes 203 located at the top corners of the specific day and class box 205 in order to promote organizational skills. The student will establish task priorities by writing in the left box 207 a number from one to five (1-5), wherein the number one will be the highest priority level and the number five will be the lowest priority level. The student will check the right box 208 when he or she has completed the task. The bottom left corner of the class box 205 provides a behavior section 206 where the parent, guardian or teacher may write a classification about the student's behavior 210, which is provided at the bottom of the page. The behavior classification system 210 consist of letters “E”, “S”, and “N”, which stand for “excellent”, “satisfactory” and “needs improvement” respectively.

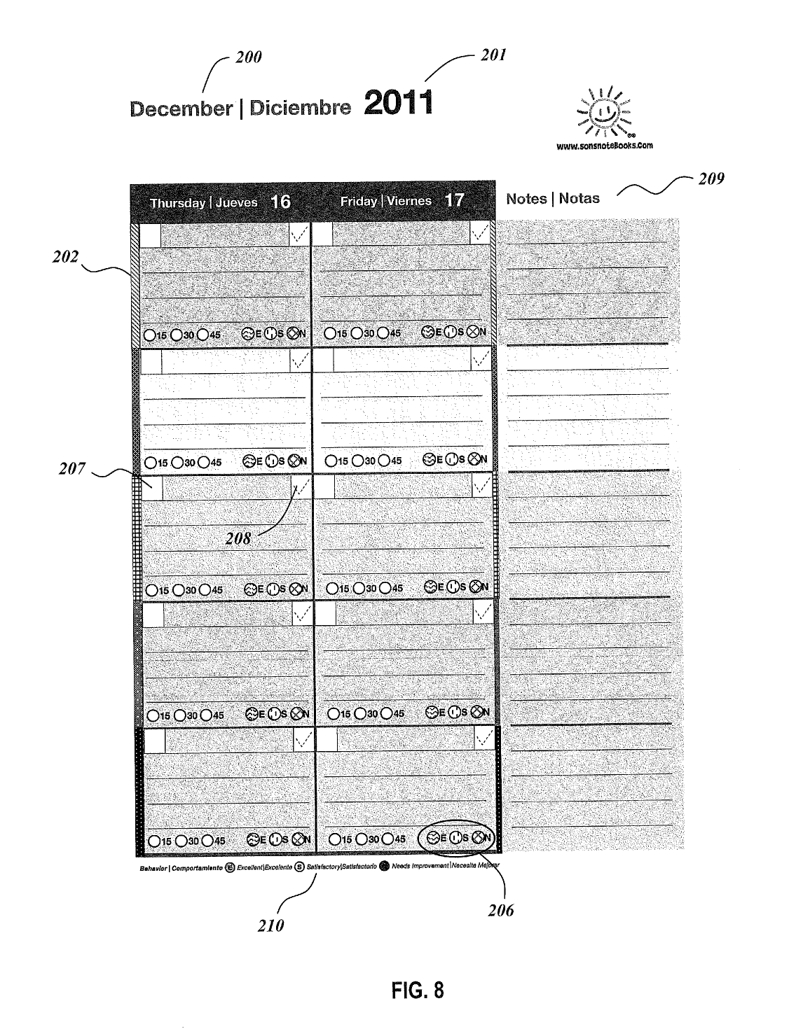

FIG. 8 is a perspective view of right page of the student organizational notebook system's agenda 11 dated within the current academic year 200, 201, wherein said page is organized into color codes 202, matching to the corresponding academic class or subject. The right page provides a space for notes 209 where the student, professor or parent may write important matters.

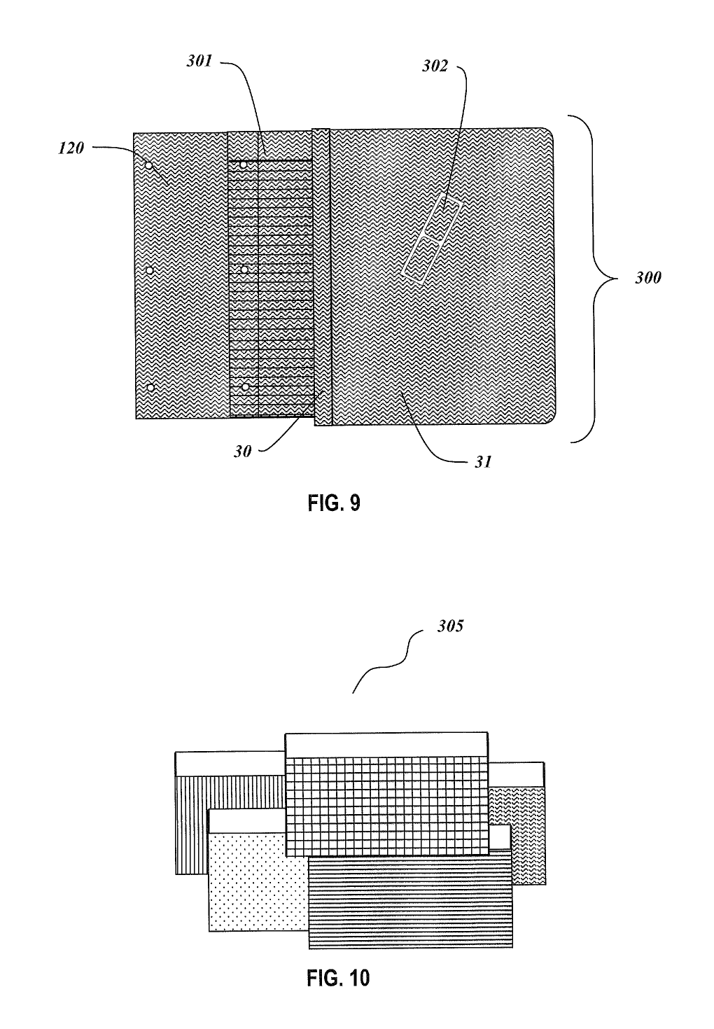

FIG. 9 is a demonstration of some of the student's organizational notebook system's constituents grouped together by matching colors 300, wherein grouped constituents, as a matter of example, consist of a file folder 120, notebook paper 301, book label 302, and notebook 31. The aforementioned constituents are the same color to help the student improve organizational, memorization and planning skills.

FIG. 10 is a perspective of the organizational system and kit color coded index cards 305, wherein said cards 305 are matched to their corresponding academic class or subject, allowing the student to improve memorization skills and quick learning.

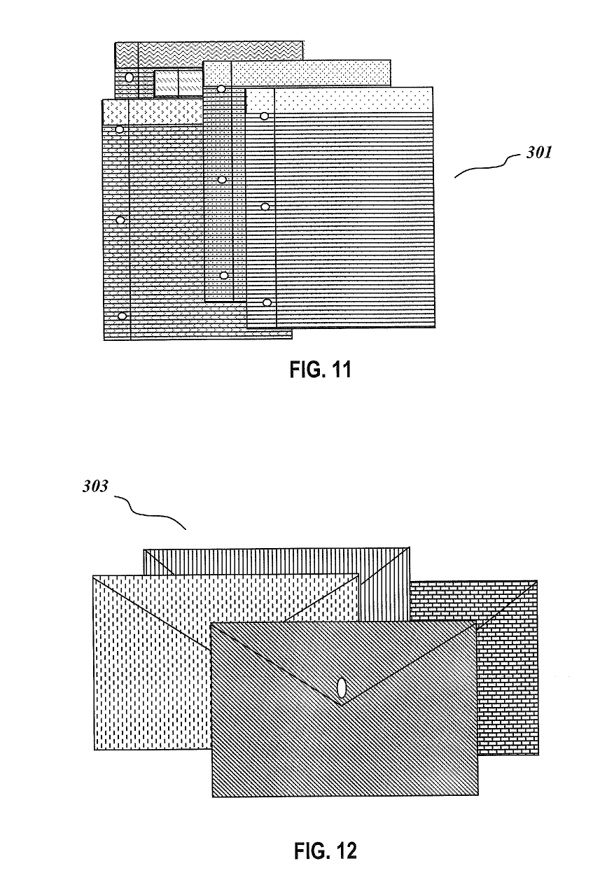

FIG. 11 is a perspective of the organizational system and kit color coded notebook papers 301, wherein said notebook papers 301 are matched to their corresponding academic class or subject. In the case a professor needs to grade school work, the student may remove notebook papers 301 from organizational system and kit ring binder 306 or any other container and place it on the student's organizational notebook system's corresponding color coded plastic envelope 303 or file folder 120 and hand it out to the professor.

FIG. 12 is a perspective of the organizational system and kit color coded plastic envelopes 303, wherein said plastic envelopes 303 are matched to their corresponding academic class or subject. The student may use the plastic envelope place important class documents. Additionally, said plastic envelopes 303 may be used to save material that will not be used, graded school work that may be used as study material for exams, projects or as future reference. To improve organizational skills, items placed in the file folders 120 will then be transferred to the plastic envelopes 303.

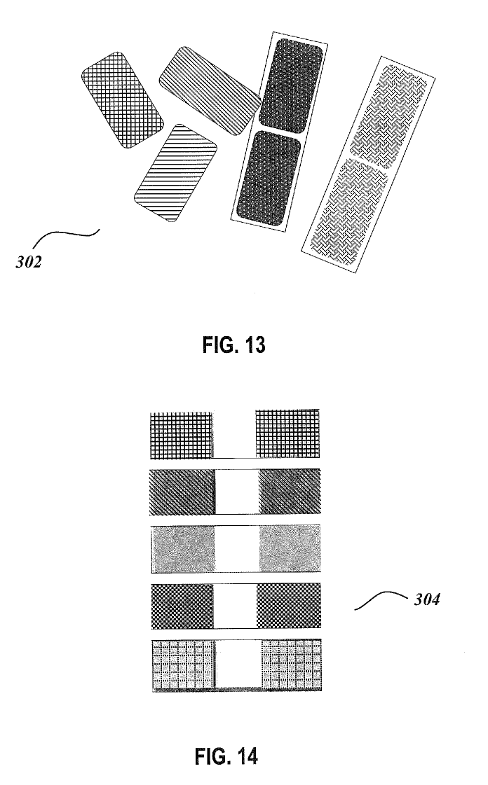

FIG. 13 is a perspective of the organizational system and kit color coded book labels 302, wherein said book labels 302 are matched to their corresponding academic class or subject. The color coded book labels may be placed on the corresponding academic class or subject textbook's spine or workbooks, among other school materials. Labeling textbooks or other school material helps the student improve his or her organizational skills especially because when the student has an assignment, he or she will take everything that is labeled the same color.

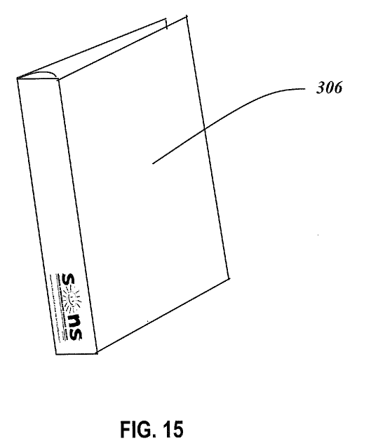

FIG. 14 is a perspective of the organizational system and kit color coded page-marker flags 304, wherein said page-marker flags 304 are matched to their corresponding academic class or subject. The student may mark, flag or highlight important information. Color coded page-markers 304 are easy to spot and easy to write on and they stick securely and remove cleanly for no document damage.

FIG. 15 is a perspective of the organizational system and kit color coded ring binder 306, wherein said color coded ring binder 306 is matched to its corresponding academic class or subject. The ring binder 306 may hold its corresponding color coded notebook paper 301 by means of clamps running through the holes of the notebook paper 301. The binder may also hold its corresponding color coded file folder 120, making it easy and convenient for the student to transfer notebook paper 301 from the ring binder 306 to the matching file folder 120, thus, improving organizational skills.

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the claims. Therefore, the above description should not be taken as limiting the scope of the invention which is defined by the appended claims.

We claim:

1. A system of organizational material comprising:
at least a first group of educational elements, wherein the first group of educational elements comprises a first identification mean;
at least a second group of educational elements, wherein the second group of educational elements comprises a second identification mean;
and an agenda comprising:
at least a first section having a first annotation mean and a first tracking mean,
and at least a second section having a second annotation mean and a second tracking mean,
wherein the first section is correlated to said first group by means of the first identification mean, and the second section is correlated to said second group by means of the second identification mean.

2. A system according to claim 1, wherein the first group of education elements comprise elements selected from; at least a notebook, at least a file folder, at least a notebook paper, at least an index card, at least a book label, at least a page-marker flag, at least a ring binder, at least an envelope;
and the second group of education elements comprise elements selected from; at least a notebook, at least a file folder, at least a notebook paper, at least an index card, at least a book label, at least a page-marker flag, at least a ring binder, at least an envelope.

3. A system according to claim 1, wherein the first identification mean comprises a first indicia; wherein the first indicia are selected from a group of colors and textures.

4. A system according to claim 3, wherein the second identification mean comprises a second indicia; wherein the second indicia are selected from a group of colors and textures.

5. A system according to claim 4, wherein the second identification mean is different from the first identification mean.

6. A system according to claim 4, wherein the first annotation mean comprises a set of ruled segments.

7. A system according to claim 4, wherein the first tracking mean comprises a progress identification mean and an array of time tracking mean.

8. A system according to claim 7, wherein the progress identification mean comprises: at least one behavior identification mean, at least one time duration identification mean; and at least one priority identification mean.

9. A system according to claim 7, wherein the behavior identification mean comprises at least one first checkmark-circle.

10. A system according to claim 7, wherein the time duration identification mean comprises at least one second checkmark-circle.

11. A system according to claim 7, wherein the priority identification mean comprises at least one checkmark-box.

12. A system according to claim 7, wherein the array of time tracking mean is selected from; years, months, weeks, days, hours, minutes, seconds.
